(19) United States
(12) Patent Application Publication
(10) Pub. No.: US 2026/0258890 A1
(43) Pub. Date: Sep. 3, 2026

(54) PLUG CONNECTOR FOR CONNECTING AN INSERTION SLEEVE TO A FLUID LINE

(71) Applicant: Henn GmbH & Co KG., Dornbirn (AT)

(72) Inventor: Harald HARTMANN, Dornbirn (AT)

(73) Assignee: Henn GmbH & Co KG., Dornbirn (AT)

(21) Appl. No.: 19/489,949

(22) PCT Filed: Jun. 5, 2024
(86) PCT No.: PCT/AT2024/060218

§ 371 Date: Dec. 4, 2025

(30) Foreign Application Priority Data
Jun. 5, 2023 (AT) A50441/2023

(51) Int. Cl. F16L 37/088

(52) U.S. Cl. CPC F16L 37/0885

(57) ABSTRACT

A plug connector for connecting a plug-in sleeve to a fluid line includes a connecting sleeve with a connecting portion that encloses a receiving space for receiving a plug-in sleeve end portion. A slide ring in the space is located closer to a first sleeve end than a sealing ring. The space includes a sealing portion limited in the direction of a second sleeve end by a circumferential shoulder, a retaining portion closer to the first sleeve end than the sealing portion, and a transition portion connecting the retaining and sealing portions and forming a sliding surface for the sealing ring. Inserting the plug-in sleeve into the space displaces the slide ring in the second-sleeve-end direction by a plug-in sleeve actuating portion and displaces the sealing ring via the sliding surface from a retaining position on the retaining portion into a sealing position on the sealing portion.

The invention relates to a plug connector for connecting a plug-in sleeve to a fluid line, wherein the plug connector has a connecting sleeve with an open first sleeve end and an open second sleeve end connected to the first sleeve end, wherein a first connecting portion for connecting the connecting sleeve to the plug-in sleeve is provided in the region of the first sleeve end and a second connecting portion for connecting the connecting sleeve to the fluid line is provided in the region of the second sleeve end, wherein the first connecting portion encloses a receiving space for receiving an end portion of the plug-in sleeve. Furthermore, the invention relates to a plug connector system comprising a plug connector and a plug-in sleeve and to a use of such a plug connector system.

Connectors of this type are usually used in a wide variety of industrial applications to connect two fluid lines, preferably in a sealed manner. This is often done as part of an assembly process during the manufacture of a specific fluid-carrying product. Depending on the specific area of application and the fluid used, the fluid lines may be essentially rigid pipes or flexible hoses. However, a fluid line may also be integrated into a component. The fluids used may be gaseous media or liquid media. The gaseous media may be (pressurised) air or certain process gases, for example. Liquid media used include water, lubricating oil, coolant, refrigerant, etc.

Often, one side of the plug connector is connected directly to one of the two fluid lines and the other fluid line is first connected to the plug-in sleeve. To connect the two lines, the plug-in sleeve may be finally coupled to the plug connector, usually in a releasable manner. A sealing ring is often provided to create a seal. The sealing ring may, for example, be pre-assembled on the connecting sleeve in a sealing position and the plug-in sleeve may be pushed into the sealing ring during the connection process.

Various plug connectors are known from WO 2018/144902A1 , WO 2018/102213 A1 and EP 3 179 148A1 .

Known plug connectors often have the disadvantage that a relatively high plug-in force is required to connect the plug-in sleeve to the plug connector. However, high plug-in forces are naturally undesirable because they make assembly more difficult. Although the plug-in force can generally be reduced by the use of lubricants, lubricants are not permitted or desired in many cases. The reasons for this are, for example, a higher tendency to soiling and incompatibility with materials or fluids.

Another method of reducing the plug-in force is to reduce the radial overlap between the plug-in sleeve and the sealing ring. However, this may lead to a reduced sealing effect, which increases the risk of leaks.

The object of the present invention was to overcome the disadvantages of the prior art and to provide a plug connector which requires a smaller maximum plug-in force.

This object is solved with the plug connector mentioned at the beginning in that the plug connector comprises a sealing ring and a slide ring, which are arranged next to one another in the receiving space, wherein the slide ring is located closer to the first sleeve end than the sealing ring, in that the receiving space comprises a sealing portion, which is limited in the direction of the second sleeve end by a circumferential shoulder, comprises a retaining portion which is located closer to the first sleeve end than the sealing portion and comprises a transition portion which connects the retaining portion to the sealing portion, wherein the transition portion configures a sliding surface for the sealing ring, wherein the slide ring can be displaced in the direction of the second sleeve end by an actuating portion of the plug-in sleeve when the plug-in sleeve is inserted into the receiving space, so that the sealing ring can be displaced by means of the slide ring from a retaining position on the retaining portion via the sliding surface of the transition portion into a sealing position on the sealing portion.

The maximum plug-in force required can be reduced by the plug connector according to the invention, because the sealing ring is initially arranged in a retaining position in the region of the retaining portion before the plug-in sleeve is inserted and, when the plug-in sleeve is inserted, the plug-in sleeve first moves relative to the sealing ring as long as the sealing ring is in the region of the retaining portion. The sealing ring has only reached its final position relative to the plug-in sleeve when the plug-in sleeve is in contact with the slide ring and no longer undergoes any relative movement with respect to the plug-in sleeve during the further plug-in process. The slide ring is now moved further by the plug-in sleeve, which moves the sealing ring into the final sealing position on the sealing portion.

The sealing portion and the retaining portion may each be cylindrical and have the same inner diameter. The transition portion is preferably also cylindrical and has the same inner diameter as the retaining portion and the sealing portion. This provides an embodiment that is easy to manufacture.

According to a preferred embodiment, the sealing portion is cylindrical and has a first inner diameter, the retaining portion is cylindrical and has a second inner diameter which is larger than the first inner diameter, wherein the transition portion tapers from the retaining portion in the direction of the sealing portion. This allows the sealing ring to be compressed to a greater extent at the sealing portion in the radial direction, which can improve the sealing effect.

Preferably, the transition portion comprises a conical sliding surface and/or a sliding surface that is curved outwards in the radial direction. This enables improved sliding of the sealing ring.

The sealing ring may have an essentially I-shaped cross-section. Alternatively or additionally, the sealing ring may have at least one sealing lip on its inner circumferential surface, which is configured to interact with an outer circumferential surface of the end portion of the plug-in sleeve for sealing in the sealing position. Such sealing rings enable an improved sealing and a lower plug-in force.

The slide ring may have a contact portion on its inner circumferential surface that tapers in the direction of the second sleeve end and is configured to interact with the actuating portion of the plug-in sleeve to displace the slide ring. Preferably, the contact portion has a conical portion and/or a portion that is curved inwards in the radial direction. This creates a relatively large contact surface and consequently enables improved force transmission from the plug-in sleeve to the slide ring.

Preferably, the plug connector comprises a locking device for locking the plug-in sleeve to the connecting sleeve. The locking device may comprise at least one passage opening which connects an outer circumferential surface of the connecting sleeve to the receiving space, and at least one locking element with at least one locking portion, wherein the at least one locking portion projects through the at least one passage opening into the receiving space, wherein the at least one locking portion is configured to be displaced out of the receiving space in a radial direction by the actuating portion of the plug-in sleeve when the plug-in sleeve is inserted into the receiving space of the connecting sleeve and then to engage inwards in the radial direction in a locking recess of the plug-in sleeve. This enables simple and reliable locking of the plug-in sleeve. The locking device may advantageously be configured in such a way that it is compatible with a standardized plug-in sleeve in accordance with the VDA standard (VDA=German Association of the Automotive Industry).

Preferably, the slide ring comprises at least one retaining surface which faces the first sleeve end and the at least one locking portion of the locking element is configured to interact with the at least one retaining surface of the slide ring to limit a displacement of the slide ring in the direction of the first sleeve end. This can prevent the slide ring and, if applicable, the sealing ring from disengaging in a delivery state (i.e. without a plug-in sleeve).

It may be advantageous if the slide ring comprises at least one retaining recess which connects an outer circumferential surface to an inner circumferential surface and which is preferably open in the direction of the first sleeve end, and that the at least one retaining recess comprises the at least one retaining surface. This means that the slide ring can be made longer, which can improve guidance in the receiving space.

Preferably, the slide ring comprises at least one guiding protrusion on the outer circumference, which extends over a part of a length of the slide ring, and at least one guiding recess is provided in the receiving space of the connecting sleeve, which extends from the first sleeve end over a part of a length of the receiving space in the direction of the second sleeve end. The at least one guiding recess is configured to interact with the at least one guiding protrusion for guiding the slide ring. This enables a defined guidance of the slide ring in the axial direction and at the same time an anti-rotation lock.

The at least one guiding recess may also be limited in the direction of the second sleeve end by a first limiting surface facing the first sleeve end, and the at least one guiding protrusion may be limited in the direction of the second sleeve end by a second limiting surface facing the second sleeve end. In the sealing position of the sealing ring, the second limiting surface of the at least one guiding protrusion may be in contact with the first limiting surface of the at least one guiding recess. This provides an advantageous defined stop for the slide ring.

It may be advantageous if an anti-rotation recess is provided on an inner circumferential surface of the receiving space of the connecting sleeve, which, starting from the first sleeve end, extends over a part of a length of the receiving space in the direction of the second sleeve end and extends in a radial direction in the direction of the outer circumferential surface of the connecting sleeve, wherein the anti-rotation recess is configured to interact with an anti-rotation protrusion of the plug-in sleeve in order to configure an anti-rotation lock. This makes it easy to provide an anti-rotation connection with the plug-in sleeve, especially with a plug-in sleeve in accordance with the VDA standard.

It may also be advantageous if the slide ring is connected to the sealing ring, preferably in a positive locking or materially locking manner, in particular by means of an adhesive connection. Among other things, this may simplify assembly.

The plug connector may be part of a plug connector system which additionally comprises a plug-in sleeve, wherein the plug-in sleeve comprises an open first plug-in sleeve end and an open second plug-in sleeve end connected to the first plug-in sleeve end, wherein the plug-in sleeve comprises a cylindrical first plug-in sleeve portion with a first outer diameter and a cylindrical second plug-in sleeve portion with a second outer diameter which is smaller relative to the first outer diameter, wherein the second plug-in sleeve portion is located closer to the second plug-in sleeve end than the first plug-in sleeve portion, wherein an actuating portion, preferably conical, tapering in the direction of the second plug-in sleeve end is provided between the first plug-in sleeve portion and the second plug-in sleeve portion, and wherein the plug-in sleeve can be inserted with the second plug-in sleeve end into the receiving space of the connecting sleeve of the plug connector, so that the slide ring of the plug connector can be displaced by the actuating portion of the plug-in sleeve in the direction of the second sleeve end, and the sealing ring can be displaced by means of the slide ring from the retaining position on the retaining portion via the sliding surface of the transition portion into the sealing position on the sealing portion.

Preferably, a locking recess is provided on the cylindrical first plug-in sleeve portion of the plug-in sleeve, which locking recess is configured to interact with the locking portion of the locking element of the locking device of the plug connector for locking the plug-in sleeve, wherein the locking recess preferably comprises a circumferential groove.

The plug connector system is preferably used in such a way that the plug-in sleeve is inserted with the second plug-in sleeve end into the receiving space of the connecting sleeve of the plug connector, wherein the sealing ring is located in the retaining position on the retaining portion, in that the plug-in sleeve is moved relative to the sealing ring, until the actuating portion of the plug-in sleeve is in contact with the slide ring of the plug connector, that the slide ring of the plug connector is displaced by the actuating portion of the plug-in sleeve in the direction of the second sleeve end and that the sealing ring is displaced by means of the slide ring from the retaining position on the retaining portion via the sliding surface of the transition portion into the sealing position on the sealing portion.

For a better understanding of the invention, it is explained in more detail with the aid of the following figures.

The figures show a simplified, schematic representation as follows:

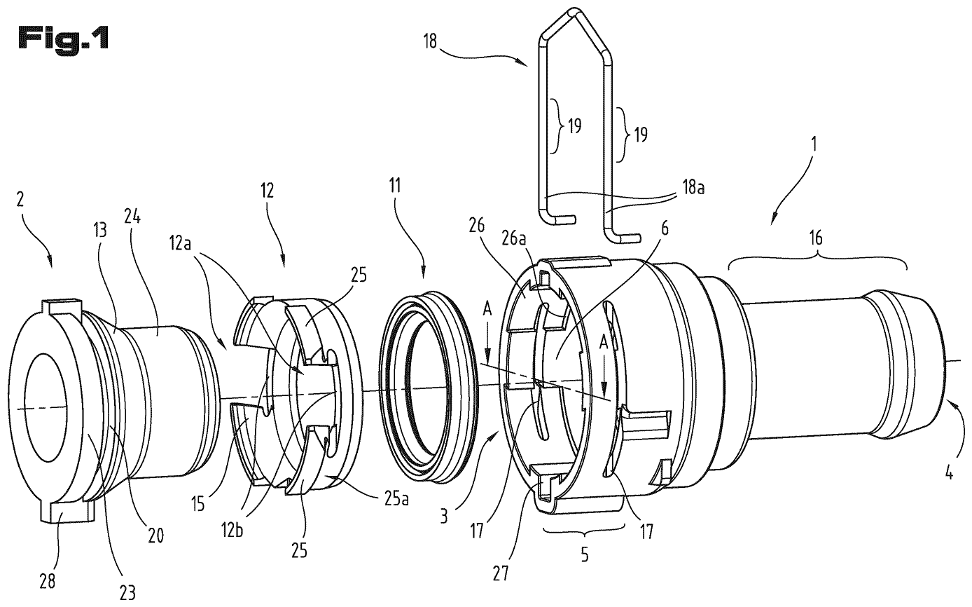

FIG. 1 a plug connector system with a plug connector and a plug-in sleeve in a perspective exploded view;

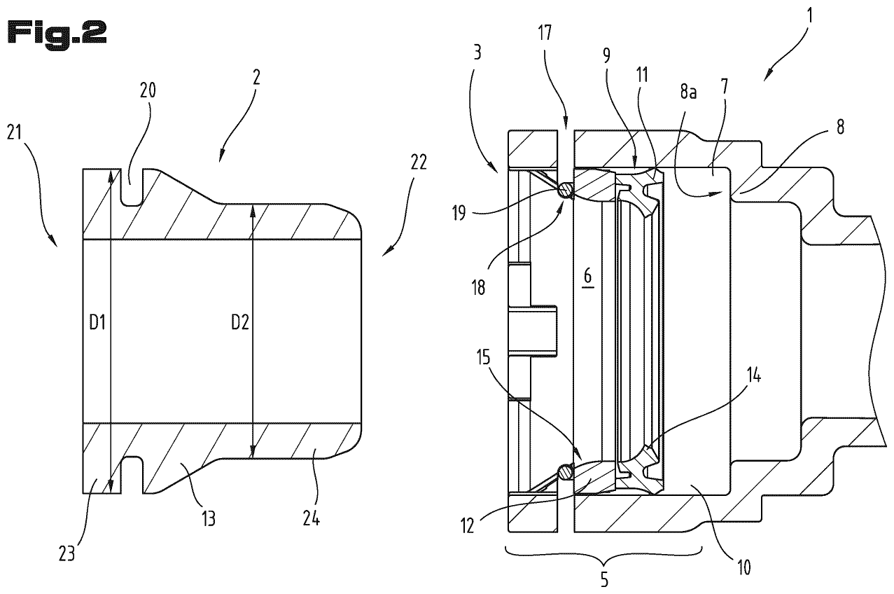

FIG. 2 the plug connector system of a first advantageous embodiment in a longitudinal section before insertion of the plug-in sleeve;

FIG. 3 the plug connector system of the first embodiment in a longitudinal section with the plug-in sleeve partially inserted;

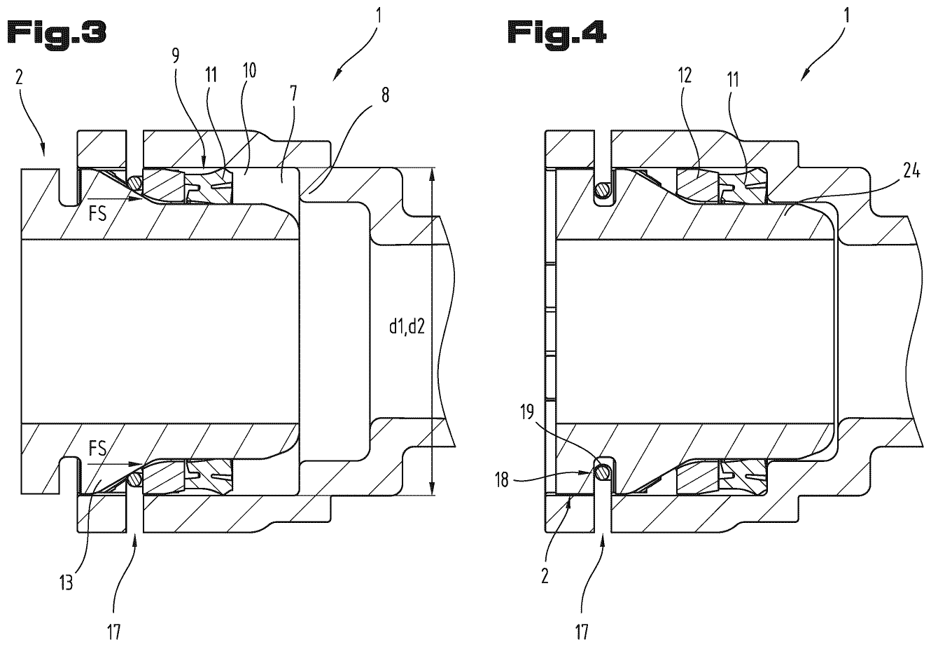

FIG. 4 the plug connector system of the first embodiment in a longitudinal section with the plug-in sleeve fully inserted;

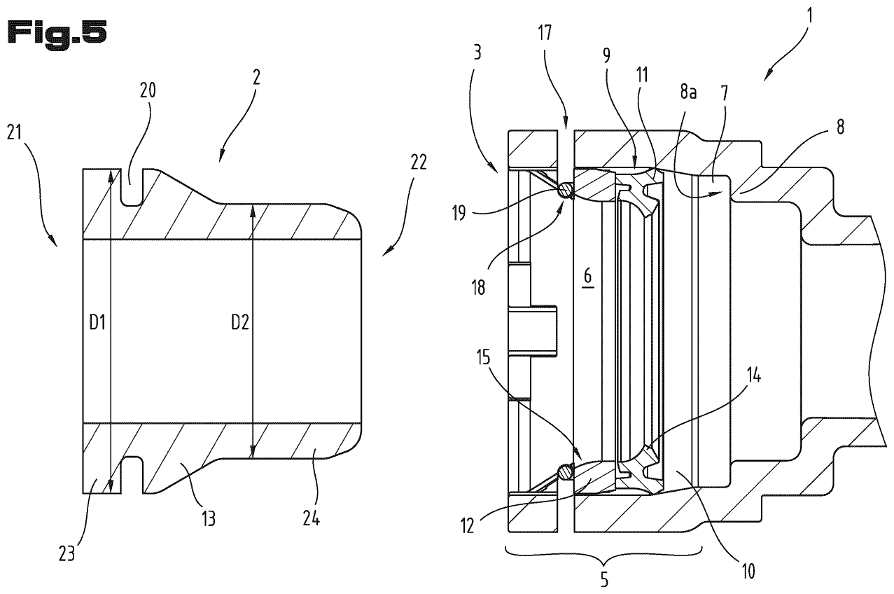

FIG. 5 the plug connector system of a second advantageous embodiment in a longitudinal section before insertion of the plug-in sleeve;

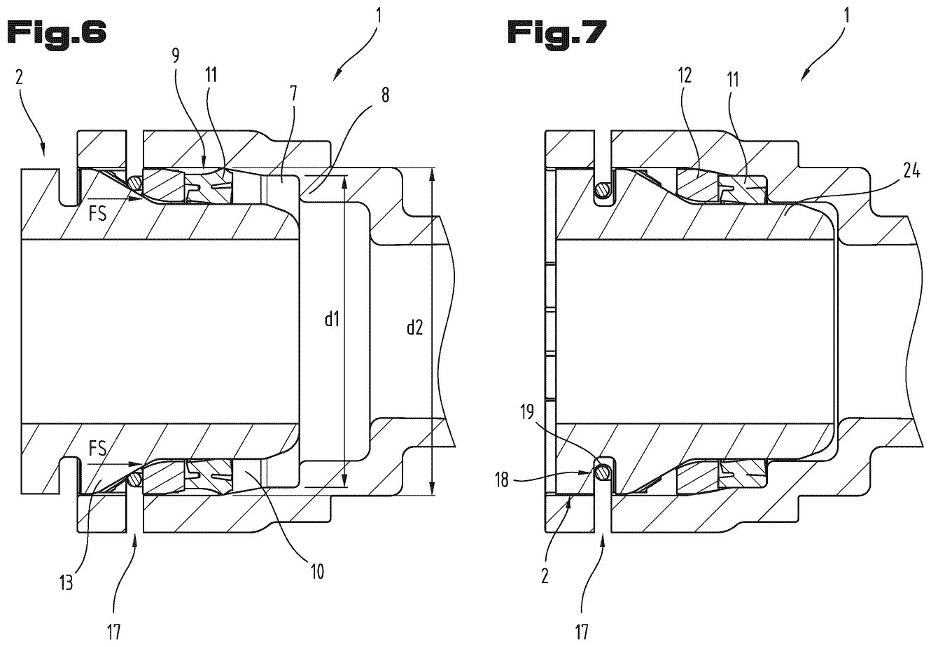

FIG. 6 the plug connector system of the second embodiment in a longitudinal section with the plug-in sleeve partially inserted;

FIG. 7 the plug connector system of the second embodiment in a longitudinal section with the plug-in sleeve fully inserted.

By way of introduction, it should be noted that in the various embodiments described, the same parts are provided with the same reference signs or the same component designations, wherein the disclosures included in the entire description may be transferred analogously to the same parts with the same reference signs or the same component designations. The position details chosen in the description, such as top, bottom, side, etc., also refer to the directly described and illustrated figure and these position details are to be transferred to the new position accordingly in the event of a change of position.

In the following, reference is first made to FIG. 1 to FIG. 4. FIG. 1 shows an exploded view of a generic plug connector system of the invention comprising a plug connector and a plug-in sleeve 2. The plug connector and/or the plug-in sleeve 2 may be made of a suitable plastic or metallic material, for example. FIG. 2 to FIG. 4 show the plug connector system according to the invention in a first embodiment, each in a longitudinal section along the section line A-A in FIG. 1. FIG. 2 shows the plug-in sleeve 2 in a state before insertion. FIG. 3 shows the plug-in sleeve 2 in a partially inserted state. FIG. 4 shows the plug-in sleeve 2 in the fully inserted state.

The connector has a connecting sleeve 1 with an open first sleeve end 3 and an open second sleeve end 4 connected to the first sleeve end 3, as can be seen in FIG. 1. The sleeve ends 3, 4 are connected via a flow channel. A first connecting portion 5 is provided in the region of the first sleeve end 3, which is configured to connect the connecting sleeve 1 to the plug-in sleeve 2. For this purpose, the first connecting portion 5 encloses a receiving space 6 into which an end portion of the plug-in sleeve 2 can be inserted, as can be seen in FIG. 3 and FIG. 4.

In the region of the second sleeve end 4, the connecting sleeve 1 can comprise a second connecting portion 16 for connecting the plug connector to a fluid line (not shown). The second connecting portion 16 in FIG. 1 is configured, for example, to provide a hose connection with a flexible hose. Depending on the area of application, the second connecting portion 16 may be configured in a suitable manner. In FIG. 2 to FIG. 4, the second connecting portion 16 is no longer shown for the sake of simplicity.

The receiving space 6 of the connecting sleeve 1 comprises a sealing portion 7, which is limited in the direction of the second sleeve end 4 by a circumferential shoulder 8. In the example shown, the sealing portion 7 has a cylindrical configuration and a first inner diameter d1 (see FIG. 3). An annular front face 8a is provided on the circumferential shoulder 8, which faces the first sleeve end 3 (see FIG. 2). Furthermore, the receiving space 6 comprises a retaining portion 9, which is located closer to the first sleeve end 3 than the sealing portion 7. In the example shown, the retaining portion 9 has also a cylindrical configuration and a second inner diameter d2, which has the same size or essentially the same size as the first inner diameter d1 (see FIG. 3). The retaining portion 9 and the sealing portion 7 are connected by a transition portion 10, which configures a sliding surface for the sealing ring 11 described in more detail below. In the first embodiment shown, the sealing portion 7, the retaining portion 9 and the intermediate transition portion 10 may be configured by a common cylindrical circumferential surface.

Furthermore, the plug connector comprises a sealing ring 11 and a slide ring 12, which are arranged next to each other in the longitudinal direction in the receiving space 6 of the connecting sleeve 1. The slide ring 12 is arranged closer to the first sleeve end 3 of the connecting sleeve 1 than the sealing ring 11, as can be seen in FIG. 2. According to an advantageous embodiment, the slide ring 12 and the sealing ring 11 can be connected to each other, for example on the front faces facing each other. The connection may be created in a positive locking or materially locking manner, for example by means of an adhesive connection. In a delivery state of the plug connector, i.e. before the plug connector is connected to the plug-in sleeve 2, the sealing ring 11 is preferably located in the region of the retaining portion 9.

The plug-in sleeve 2 may comprise an open first plug-in sleeve end 21 and an open second plug-in sleeve end 22 connected to the first plug-in sleeve end 21, as shown in FIG. 2. The plug-in sleeve 2 preferably has a cylindrical first plug-in sleeve portion 23 with a first outer diameter D1 and a cylindrical second plug-in sleeve portion 24 with a second outer diameter D2 that is smaller relative to the first outer diameter D1, as can be seen in FIG. 2. The second plug-in sleeve portion 24 is located closer to the second plug-in sleeve end 22 than the first plug-in sleeve portion 23.

An actuating portion 13 tapering in the direction of the second plug-in sleeve end 22 may be provided between the first plug-in sleeve portion 23 and the second plug-in sleeve portion 24. The actuating portion 13 has preferably a conical configuration. Preferably, the actuating portion 13 connects the first plug-in sleeve portion 23 directly to the second plug-in sleeve portion 24. Of course, production-related radii may be provided at the transitions, similar to the transition portion 10 of the plug connector.

When the plug-in sleeve 2 is inserted into the receiving space 6 of the connecting sleeve 1, a plug-in force FS can be transmitted to the slide ring 12 via the, preferably conical, actuating portion 13 of the plug-in sleeve 2, as indicated by the corresponding arrow in FIG. 3. The plug-in force FS allows the slide ring 12 to be displaced within the receiving space 6 in the direction of the second sleeve end 4 or in the direction of the sealing portion 7. The plug-in force FS can be transferred further from the slide ring 12 to the sealing ring 11. This allows the sealing ring 11 to be displaced from the retaining position on the retaining portion 9 shown in FIG. 3 via the sliding surface of the transition portion 10 into a sealing position on the sealing portion 7 by means of the slide ring 12. The sealing position of the sealing ring 11 is shown in FIG. 4.

When inserting the plug-in sleeve 2, a relative movement is thus initially performed between the (moving) plug-in sleeve 2 and the (stationary) sealing ring 11 until the actuating portion 13 of the plug-in sleeve 2 is in contact with the slide ring 12. As soon as the actuating portion 13 of the plug-in sleeve 2 is in contact with the slide ring 12, the relative movement between the plug-in sleeve 2 and the sealing ring 11 is completed and the sealing ring 11 is in its final position in relation to the plug-in sleeve 2. As the plug-in sleeve 2 is inserted further, the plug-in force FS is now transferred from the slide ring 12 to the sealing ring 11. This moves the sealing ring 11, the slide ring 12 and the plug-in sleeve 2 in a joint relative movement relative to the connecting sleeve 1 in the direction of the second sleeve end 4. The sealing ring 11 is pushed from the retaining portion 9 via the sliding surface of the transition portion 10 into its final sealing position on the sealing portion 7.

The sealing ring 11 may, for example, have an essentially I-shaped cross-section. Alternatively or additionally, the sealing ring 11 may have one or more sealing lips 14 on its inner circumferential surface, which are configured to interact with an outer circumferential surface of the end portion of the plug-in sleeve 2 for sealing in the sealing position, in particular with the second plug-in sleeve portion 24, as can be seen in FIG. 4.

Preferably, the plug connector also has a locking device for locking the plug-in sleeve 2. The locking device may, for example, comprise a passage opening 17, which connects an outer circumferential surface of the connecting sleeve 1 with the receiving space 6, as can be seen in particular in FIG. 1. Furthermore, the locking device may comprise a locking element 18 with a locking portion 19, wherein the locking portion 19 projects through the through opening 17 into the receiving space 6 of the connecting sleeve 1, as can be seen in FIG. 2.

In the embodiment shown (see FIG. 1), for example, two groove-shaped passage openings 17 are provided, which are arranged diametrically opposite each other on the connecting sleeve 1 and which each extend in the circumferential direction over a part of the circumference of the connecting sleeve 1. The locking element 18 is configured here as an essentially U-shaped clip that can be pushed onto the connecting sleeve 1 in a radial direction. The clip has two legs 18a, wherein each leg comprises an angled end. Each leg 18a also comprises a locking portion 19. Portions located centrally with respect to a longitudinal extension of the respective leg 18a function here as locking portions 19, as indicated in FIG. 1.

The clip may be arranged on the connecting sleeve 1 in such a way that the legs 18a are received essentially tangentially in the groove-shaped passage openings 17 with respect to the connecting sleeve 1 and the locking portions 19 are each located in the receiving space 6 of the connecting sleeve 1, as can be seen in the sectional views according to FIG. 2.

It may be advantageous if the slide ring 12 comprises one or more retaining surfaces 12b, each of which faces the first sleeve end 3 of the connecting sleeve 1. The locking portion(s) 19 of the locking element 18 may each interact with a retaining surface 12b of the slide ring 12 in order to limit a displacement of the slide ring 12 in the direction of the first sleeve end 3 of the connecting sleeve 1. This may prevent undesired disengagement of the slide ring 12 from the receiving space 6 of the connecting sleeve 1.

According to a preferred embodiment, the slide ring 12 may have a plurality of retaining recesses 12a, each of which connects an outer circumferential surface of the slide ring 12 to an inner circumferential surface. The retaining recesses 12a are preferably each open in the direction of the first sleeve end 3 of the connecting sleeve 1, as can be seen in FIG. 1. The retaining recesses 12a may each comprise one of the above-mentioned retaining surfaces 12b. As can be seen in FIG. 2, the slide ring 12 may be arranged in the receiving space 6 of the connecting sleeve 1 in such a way that the locking portions 19 of the locking element 18 project in the radial direction through the retaining recesses 12b of the slide ring 12 into the receiving space 6 of the connecting sleeve 1 and in each case interact with the corresponding retaining surface 12b in order to limit a movement of the slide ring 12 in the direction of the first sleeve end 3.

A locking recess 20 may be provided on the plug-in sleeve 2, in particular on the first plug-in sleeve portion 23. The locking recess 20 may, for example, comprise one or more circumferential grooves, each of which extends in the circumferential direction over a part of the plug-in sleeve 2. A circumferential groove may also be provided, which preferably extends around the entire circumference of the plug-in sleeve 2. When inserting the plug-in sleeve 2 into the receiving space 6 of the connecting sleeve 1, the locking portions 19 of the locking element 18 may initially be brought in contact by the preferably conical actuating portion 13 of the plug-in sleeve 2 (see FIG. 3) and may be displaced from the receiving space 6 of the connecting sleeve 1 in a radial direction.

When inserting the plug-in sleeve 2 further, the locking portions 19 may then engage in the available locking recesses 20 of the plug-in sleeve 2, as can be seen in FIG. 4. For this purpose, the locking element 18, in particular the clip, may be pretensioned inwards in a radial direction, for example. This allows the plug-in sleeve 2 to be locked in a positive locking manner onto the plug connector. The locking mechanism may be disengaged using a suitable tool, for example. In principle, however, the locking mechanism could also be configured to be non-disengageable, e.g. if disengaging after connection is undesirable. Of course, the locking mechanism shown is only an example. Depending on the specific application, the skilled person may select a suitable configuration.

As can be seen in FIG. 2, the slide ring 12 may have a contact portion 15 on the inner circumferential surface that tapers in the direction of the second sleeve end 4. The contact portion 15 is configured to interact with the actuating portion 13 of the plug-in sleeve 2 to displace the slide ring 12. The contact portion 15 may, for example, have a conical contact surface and/or a (convex) contact surface curved inwards in the radial direction. As a result, the actuating portion 13 is in contact with a relatively large surface on the slide ring 12, which enables good force transmission with little risk of damage to the slide ring 12.

Furthermore, the slide ring 12 may comprise one or more guiding protrusions 25 on its outer circumference, each of which extends over a part of a length of the slide ring 12. One or more guiding recesses 26 may be provided in the receiving space 6 of the connecting sleeve 1, each of which extends from the first sleeve end 3 over a part of a length of the receiving space 6 in the direction of the second sleeve end 4. The guiding recesses 26 are configured to interact with guiding protrusions 25 for guiding the slide ring 12. In the embodiment shown in FIG. 1, the slide ring 12 has four guiding protrusions 25, for example, which are spaced at 90° from each other in the circumferential direction. The connecting sleeve 1 has four corresponding guiding recesses 26.

The guiding recesses 26 may each be limited in the direction of the second sleeve end 4 by a first limiting surface 26a facing the first sleeve end 3, as can be seen in FIG. 1. The guiding protrusions 25 may each be limited in the direction of the second sleeve end 4 by a second limiting surface 25a facing the second sleeve end 4. When the sealing ring 11 is in the sealing position on the sealing portion 7, the second limiting surfaces 25a of the guiding protrusions 25 are in contact with the first limiting surfaces 26a of the guiding recesses 26. This may prevent the sealing ring 11 from being subjected to excessive stress in the longitudinal direction, which may lead to undesirable deformation and an associated reduction in the sealing effect, up to and including damage to the sealing ring 11.

Furthermore, one or more anti-rotation recesses 27 may be provided on an inner circumferential surface in the receiving space 6 of the connecting sleeve 1. In the longitudinal direction, the anti-rotation recesses 27 each extend from the first sleeve end 3 over a part of a length of the receiving space 6 in the direction of the second sleeve end 4. In the radial direction, the anti-rotation recesses 27 each extend in the direction of the outer circumferential surface of the connecting sleeve 1. The anti-rotation recesses 27 are configured to interact with an anti-rotation projection 28 of the plug-in sleeve 2 in order to form an anti-rotation lock. In order to allow sufficient depth in the radial direction, the connecting sleeve 1 may have an increased wall thickness in the region of the anti-rotation recesses 27, e.g. in the form of integral protrusions, as can be seen in FIG. 1.

The shape, size and position of the anti-rotation recesses 27 may be determined, for example, depending on the configuration of the plug-in sleeve 2. This allows the plug connector to be adapted to a standardized VDA plug-in sleeve in an advantageous way. In the embodiment shown, the plug-in sleeve 2 comprises, for example, two anti-rotation projections 28, which are arranged diametrically opposite one another on the first plug-in sleeve portion 23 of the plug-in sleeve 2. The connecting sleeve 1 accordingly comprises two anti-rotation recesses 27 diametrically opposite one another. The anti-rotation recesses 27 can essentially be regarded as grooves and the anti-rotation projection 28 as tongues of a tongue and groove connection. In the example shown, the groove-shaped locking recess 20 of the plug-in sleeve 2 running around the circumference comprises two separate circumferential grooves, which are separated by the two anti-rotation projections 28.

FIG. 5 to FIG. 7 show the plug connector system according to the invention in a second embodiment, in each case in a longitudinal section along the sectional line A-A in FIG. 1. In FIG. 5, the plug-in sleeve 2 is shown in a state before insertion, as in FIG. 2. In FIG. 6, the plug-in sleeve 2 is shown in a partially inserted state, as in FIG. 3. In FIG. 7, the plug-in sleeve 2 is shown fully inserted, as in FIG. 4. Only the differences to the first embodiment are described in detail below. In addition, the second embodiment may be configured in the same way as the first embodiment. The individual features are therefore not repeated and reference is made to the explanations above for FIG. 2 to FIG. 4, which are also valid for the second embodiment.

The sealing portion 7 has a cylindrical configuration here and a first inner diameter d1. The retaining portion 9 has also a cylindrical configuration and a second inner diameter d2 that is larger than the first inner diameter d1. In contrast to the first embodiment, the transition portion 10 has therefore no longer a cylindrical configuration, but tapers from the retaining portion 9 in the direction of the sealing portion 7, as can be seen in FIG. 5. The transition portion 10 in turn forms the sliding surface for the sealing ring 11.

The sliding surface may, for example, comprise a conical sliding surface and/or a sliding surface that is curved outwards in the radial direction. Preferably, the transition portion 10 connects the retaining portion 9 essentially directly to the sealing portion 7. “Essentially” here means that, for example, a production-related radius may be provided at the transition between the retaining portion 9 and the transition portion 9 or at the transition between the transition portion 9 and the sealing portion 7.

When inserting the plug-in sleeve 2, a relative movement is again initially performed between the (moving) plug-in sleeve 2 and the (stationary) sealing ring 11 until the actuating portion 13 of the plug-in sleeve 2 is in contact with the slide ring 12. As the plug-in sleeve 2 is inserted further, the plug-in force FS is now transferred again from the slide ring 12 to the sealing ring 11. This moves the sealing ring 11, the slide ring 12 and the plug-in sleeve 2 in a joint relative movement relative to the connecting sleeve 1 in the direction of the second sleeve end 4. The sealing ring 11 is now moved from the retaining portion 9 over the, for example, conical sliding surface of the transition portion 10 onto the sealing portion 7, where it reaches its final sealing position. In the second embodiment, the sealing ring 11 may be compressed more in the radial direction compared to the first embodiment, whereby an improved sealing effect can be achieved.

The sealing ring 11 of the first embodiment and the sealing ring 11 of the second embodiment may be configured identically in principle, but could also differ. In order to achieve a sufficiently high sealing effect in the first embodiment, the sealing ring 11 could, for example, have a slightly larger outer diameter than the sealing ring 11 of the second embodiment (with otherwise identical second inner diameters d2 of the retaining portions 9).

The exemplary embodiments show possible embodiment variants, wherein it should be noted at this point that the invention is not limited to the specifically illustrated embodiment variants thereof, but rather various combinations of the individual embodiment variants with one another are also possible and this variation possibility lies within the ability of the skilled person working in this technical field due to the teaching on technical action by the present invention.

The scope of protection is determined by the claims. However, the description and the drawings should be consulted to interpret the claims. Individual features or combinations of features from the various exemplary embodiments shown and described may constitute inventive solutions in their own right. The object underlying the independent inventive solutions may be taken from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

List of reference signs

| | |
|---|---|
| 1 | connecting sleeve |
| 2 | plug-in sleeve |
| 3 | first sleeve end |
| 4 | second sleeve end |
| 5 | first connecting portion |
| 6 | receiving space |
| 7 | sealing portion |
| 8 | circumferential shoulder |
| 8a | front face |
| 9 | retaining portion |
| 10 | transition portion |
| 11 | sealing ring |
| 12 | slide ring |
| 12a | retaining recess |
| 12b | retaining surface |
| 13 | actuating portion |
| 14 | sealing lip |
| 15 | contact portion |
| 16 | second connecting portion |
| 17 | passage opening |
| 18 | locking element |
| 18a | legs |
| 19 | locking portion |
| 20 | locking recess |
| 21 | first plug-in sleeve end |
| 22 | second plug-in sleeve end |
| 23 | first plug-in sleeve portion |
| 24 | second plug-in sleeve portion |
| 25 | guiding protrusion |
| 25a | second limiting surface |
| 26 | guiding recess |
| 26a | first limiting surface |
| 27 | anti-rotation recess |
| 28 | anti-rotation protrusion |
| FS | plug-in force |
| d1 | first inner diameter |
| d2 | second inner diameter |
| D1 | first outer diameter |
| D2 | second outer diameter |

1. A plug connector for connecting a plug-in sleeve (2) to a fluid line, wherein the plug connector has a connecting sleeve (1) with an open first sleeve end (3) and an open second sleeve end (4) connected to the first sleeve end (3), wherein a first connecting portion (5) for connecting the connecting sleeve (1) to the plug-in sleeve (2) is provided in the region of the first sleeve end (3) and a second connecting portion (16) for connecting the connecting sleeve (1) to the fluid line is provided in the region of the second sleeve end (4), wherein the first connecting portion (5) encloses a receiving space (6) for receiving an end portion of the plug-in sleeve (2), wherein the plug connector comprises a sealing ring (11) and a slide ring (12), which are arranged next to one another in the receiving space (6), wherein the slide ring (12) is located closer to the first sleeve end (3) than the sealing ring (11), wherein the receiving space (6) comprises a sealing portion (7) which is limited in the direction of the second sleeve end (4) by a circumferential shoulder (8), comprises a retaining portion (9) which lies closer to the first sleeve end (3) than the sealing portion (7) and comprises a transition portion (10) which connects the retaining portion (9) to the sealing portion (7), wherein the transition portion (10) configures a sliding surface for the sealing ring (11), wherein the slide ring (12) can be displaced in the direction of the second sleeve end (4) by an actuating portion (13) of the plug-in sleeve (2) when the plug-in sleeve (2) is inserted into the receiving space (6), so that the sealing ring (11) can be displaced by means of the slide ring (12) from a retaining position on the retaining portion (9) via the sliding surface of the transition portion (10) into a sealing position on the sealing portion (7).

2. The plug connector according to claim 1, wherein the sealing portion (7) is cylindrical and has a first inner diameter (d1) and wherein the retaining portion (9) is cylindrical and has a second inner diameter (d2) which has the same size as the first inner diameter (d1).

3. The plug connector according to claim 1, wherein the sealing portion (7) is cylindrical and has a first inner diameter (d1), wherein the retaining portion (9) is cylindrical and has a second inner diameter (d2) which is larger than the first inner diameter (d1), wherein the transition portion (10) tapers from the retaining portion (9) in the direction of the sealing portion (7).

4. The plug connector according to claim 3, wherein the transition portion (10) comprises a conical sliding surface and/or a sliding surface that is curved outwards in the radial direction.

5. The plug connector according to claim 1, wherein the sealing ring (11) has a substantially I-shaped cross-section.

6. The plug connector according to claim 1, wherein the sealing ring (11) has at least one sealing lip (14) on an inner circumferential surface of the sealing ring (11), which is configured to interact with an outer circumferential surface of the end portion of the plug-in sleeve (2) for sealing in the sealing position.

7. The plug connector according to claim 1, wherein the slide ring (12) has on an inner circumferential surface of the slide ring (12) a contact portion (15) which tapers in the direction of the second sleeve end (4) and is configured to interact with the actuating portion (13) of the plug-in sleeve (2) for displacing the slide ring (12), wherein the contact portion (15) preferably comprises a conical contact surface and/or a contact surface curved inwards in the radial direction.

8. The plug connector according to claim 1, wherein the plug connector comprises a locking device for locking the plug-in sleeve (2) to the connecting sleeve (1).

9. The plug connector according to claim 8, wherein the locking device comprises at least one passage opening (17), which connects an outer circumferential surface of the connecting sleeve (1) to the receiving space (6), and at least one locking element (18) with at least one locking portion (19), wherein the at least one locking portion (19) projects through the at least one passage opening (17) into the receiving space (6), wherein the at least one locking portion (19) is configured to be displaced outwards out of the receiving space (6) in the radial direction by the actuating portion (13) of the plug-in sleeve (2) when the plug-in sleeve (2) is inserted into the receiving space (6) of the connecting sleeve (1) and then to engage inwards in the radial direction in a locking recess (20) of the plug-in sleeve (2).

10. The plug connector according to claim 9, wherein the slide ring (12) comprises at least one retaining surface (12b) which faces the first sleeve end (3), and wherein the at least one locking portion (19) is configured to interact with the at least one retaining surface (12b) of the slide ring (12) in order to limit a displacement of the slide ring (12) in the direction of the first sleeve end (3).

11. 1The plug connector according to claim 10, wherein the slide ring (12) comprises at least one retaining recess (12a) which connects an outer circumferential surface to an inner circumferential surface and which is preferably open in the direction of the first sleeve end (3), and wherein the at least one retaining recess (12a) comprises the at least one retaining surface (12b).

12. The plug connector according to claim 1, wherein the slide ring (12) comprises at least one guiding protrusion (25) on the outer circumference, which extends over a part of a length of the slide ring (12), wherein at least one guiding recess (26) is provided in the receiving space (6) of the connecting sleeve (1), which, starting from the first sleeve end (3), extends over a part of a length of the receiving space (6) in the direction of the second sleeve end (4), and wherein the at least one guiding recess (26) is configured to interact with the at least one guiding protrusion (25) for guiding the slide ring (12).

13. The plug connector according to claim 1, wherein the at least one guiding recess (26) is limited in the direction of the second sleeve end (4) by a first limiting surface (26a) facing the first sleeve end (3), wherein the at least one guiding protrusion (25) is limited in the direction of the second sleeve end (4) by a second limiting surface (25a) facing the second sleeve end (4), and wherein the second limiting surface (25a) of the at least one guiding protrusion (25) is in contact with the first limiting surface (26a) of the at least one guiding recess (26) in the sealing position of the sealing ring (11).

14. The plug connector according to claim 1, wherein an anti-rotation recess (27) is provided on an inner circumferential surface of the receiving space (6) of the connecting sleeve (1), which, starting from the first sleeve end (3), extends over a part of a length of the receiving space (6) in the direction of the second sleeve end (4) and extends in a radial direction in the direction of the outer circumferential surface of the connecting sleeve (1), and wherein the anti-rotation recess (27) is configured to interact with an anti-rotation protrusion (28) of the plug-in sleeve (2) in order to configure an anti-rotation lock.

15. The plug connector according to claim 1, wherein the slide ring (12) is connected to the sealing ring (11), preferably in a positive locking or materially locking manner, in particular by means of an adhesive connection.

16. A plug connector system comprising the plug connector according claim 1 and a plug-in sleeve (2), wherein the plug-in sleeve (2) comprises an open first plug-in sleeve end (21) and an open second plug-in sleeve end (22) connected to the first plug-in sleeve end (21), wherein the plug-in sleeve (2) comprises a cylindrical first plug-in sleeve portion (23) with a first outer diameter (D1) and a cylindrical second plug-in sleeve portion (24) with a second outer diameter (D2) which is smaller relative to the first outer diameter, wherein the second plug-in sleeve portion (24) is located closer to the second plug-in sleeve end (22) than the first plug-in sleeve portion (23), wherein an actuating portion (13), preferably conical, tapering in the direction of the second plug-in sleeve end (22) is provided between the first plug-in sleeve portion (23) and the second plug-in sleeve portion (24), and wherein the plug-in sleeve (2) can be inserted with the second plug-in sleeve end (22) into the receiving space (6) of the connecting sleeve (1) of the plug connector, so that the slide ring (12) of the plug connector can be displaced by the actuating portion (13) of the plug-in sleeve (2) in the direction of the second sleeve end (4), so that the sealing ring (11) can be displaced by means of the slide ring (12) from the retaining position on the retaining portion (9) via the sliding surface of the transition portion (10) into the sealing position on the sealing portion (7).

17. The plug connector system according to claim 16,
wherein the locking device comprises at least one passage opening (17), which connects an outer circumferential surface of the connecting sleeve (1) to the receiving space (6), and at least one locking element (18) with at least one locking portion (19), wherein the at least one locking portion (19) projects through the at least one passage opening (17) into the receiving space (6), wherein the at least one locking portion (19) is configured to be displaced outwards out of the receiving space (6) in the radial direction by the actuating portion (13) of the plug-in sleeve (2) when the plug-in sleeve (2) is inserted into the receiving space (6) of the connecting sleeve (1) and then to engage inwards in the radial direction in a locking recess (20) of the plug-in sleeve (2); and
wherein a locking recess (20) is provided on the cylindrical first plug-in sleeve portion (23) of the plug-in sleeve (2), wherein the locking recess (20) is configured to cooperate with the locking portion (19) of the locking element (18) of the locking device of the plug connector for locking the plug-in sleeve (2), wherein the locking recess (20) preferably comprises at least one circumferential groove.

18. A method of using the plug connector system according to claim 16, comprising:
inserting the plug-in sleeve (2) with the second plug-in sleeve end (22) into the receiving space (6) of the connecting sleeve (1) of the plug connector, wherein the sealing ring (11) is located in the retaining position on the retaining portion (9),
moving the plug-in sleeve (2) relative to the sealing ring (11), until the actuating portion (13) of the plug-in sleeve (2) is in contact with the slide ring (12) of the plug connector,
displacing the slide ring (12) of the plug connector by the actuating portion (13) of the plug-in sleeve (2) in the direction of the second sleeve end (4) and
displacing the sealing ring (11) using the slide ring (12) from the retaining position on the retaining portion (9) via the sliding surface of the transition portion (10) into the sealing position on the sealing portion (7).
